(19) United States
(12) Patent Application Publication
(10) Pub. No.: US 2012/0058000 A1
(43) Pub. Date: Mar. 8, 2012

(54) Self-Aligning Rod Seal

(75) Inventors: Russell Alan Rogers, Tulsa, OK (US); Christopher Lee Cackler, Jenks, OK (US)

(73) Assignee: NATIONAL OILWELL VARCO, L.P., Houston, TX (US)

(21) Appl. No.: 12/876,202

(22) Filed: Sep. 6, 2010

(51) Int. Cl. F04B 53/00; F16J 15/16

(52) U.S. Cl. 417/437; 277/500

(57) ABSTRACT

A seal assembly for providing a seal around a non-stationary rod includes a seal housing with a hollow body with first and second ends. The first end has a first opening to allow the non-stationary rod to pass therethrough and the second end has a second opening to allow the non-stationary rod to pass therethrough. A seal cartridge is disposed within the seal housing and radially moveable within the seal housing. A rod seal is disposed in an internal diameter of the seal cartridge.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Reciprocating pumps are used in a wide number of applications to pump fluid, and are particularly adapted to pumping large volumes of fluid at pressure. FIG. 1A shows cross-section of a power end 101 of a prior art reciprocating pump. This design of pump is known as a triplex reciprocating pump because there are three sections like what is shown in FIG. 1A.

The power end 101 provides the reciprocating axial motion for a piston to pump fluid in the section of the reciprocating pump known as the fluid end (not shown). In the modular design typical of reciprocating pumps, the fluid end is fastened to plate 120 on the power end. Rotating shaft 104 is rotated by an electric motor powered by a separate power source or may be directly powered by combustion. Rotating shaft 104 drives each section in the triplex reciprocating pump. A crosshead 102 converts the rotational motion of the rotating shaft 104 into axial reciprocation within cylinder 107. A rod 110, commonly referred to as a pony rod, connects the crosshead 102 to a piston (not shown) in the fluid end to provide the pumping force. The piston may be, for example, a piston rod or plunger. The pony rod and piston rod or plunger could be the same rod, but are usually separate components for the large reciprocating pumps typical for pumping fluid because the resulting unitary rod would be difficult for personnel to install and replace. Within this disclosure, “piston” will be used as the generic term to refer to any configuration of pistons, rods, or plungers that pumps the fluid.

The rod 110 passes through an opening in partition 106 in which a seal assembly 1B is installed, which is shown in greater detail in FIG. 1B. The movement of the rotating shaft 104 and crosshead 102 is lubricated by fluid, such as oil, that is pooled in lower section 103 in the power end 101. Seal assembly 1B acts as a bearing for the pony rod 110 while also trying to prevent the fluid from flowing out of the power end 101 as the pony rod 110 reciprocates. The seal assembly 1B and the pony rod 110 are accessible by removing cover 111. This prior art seal assembly 1B includes a seal body 155 with a seal 156 to seal the outer diameter of the seal body 155 with the inside of the opening in partition 106. The seal body 155 holds a seal arrangement that includes multiple chevron seals 160, in this case four, to seal around the pony rod 110. A back-up ring 161 traps the chevron seals 160 on the seal body 155. A gland 150 holds the seal assembly together and is attached to the partition 106 by multiple threaded fasteners 151 and 152. The back-up ring 161 and the chevron seals 160 are retained on the seal body 155 by the gland 150.

Though this sealing arrangement has been in use for many years, fluid often leaks past the rod seals as the pony rod 110 reciprocates, with more leaking as the pony rod 110 reciprocates at higher speeds.

### BRIEF SUMMARY OF THE DISCLOSURE

In one aspect, the disclosure relates to a seal assembly for providing a seal around a non-stationary rod. The seal assembly includes a seal housing with a hollow body with first and second ends. The first end has a first opening to allow the non-stationary rod to pass therethrough, and the second end has a second opening to allow the non-stationary rod to pass therethrough. A seal cartridge is disposed within the seal housing and radially moveable within the seal housing. A rod seal is disposed in an internal diameter of the seal cartridge.

In another aspect, the disclosure relates to a reciprocating pump with a power end and a fluid end. The power end includes a reciprocating crosshead converting rotational motion from a rotating shaft to a reciprocal motion. The fluid end includes a fluid inlet, a fluid outlet, and a piston. A pony rod extends from the reciprocating crosshead to the piston. The reciprocating pump further includes a partition between the reciprocating crosshead and the fluid end. The partition includes an opening through which the pony rod extends. A seal assembly is disposed at the opening in the partition to provide a seal between the seal housing and the opening in the partition through which the pony rod extends. The seal assembly includes a seal housing with a hollow body with first and second ends. The first end has a first opening to allow the non-stationary rod to pass therethrough and the second end has a second opening to allow the non-stationary rod to pass therethrough. A seal cartridge is disposed within the seal housing and radially moveable within the seal housing. A rod seal is disposed in an internal diameter of the seal cartridge.

Other exemplary embodiments and advantages of the invention will be apparent from the following description and the appended claims.

### BRIEF DESCRIPTION OF THE DRAWINGS

FIG. 1A is a partial cross-section of a power end of a reciprocating pump with a prior art rod seal;

FIG. 1B is a detailed cross-section of the prior art rod seal shown in FIG. 1A;

FIG. 2A is a partial cross-section of a reciprocating pump with a self-aligning rod seal in accordance with one embodiment; and

FIG. 2B is a detailed cross-section of the self-aligning rod seal shown in FIG. 2A.

### DETAILED DESCRIPTION

Embodiments of the disclosure relate generally to a sealing assembly for sealing around a non-stationary rod. Non-stationary rods that may be sealed around using embodiments of the disclosure include but are not limited to reciprocating rods, oscillating rods and rotating rods. In the description that follows, like parts are generally marked throughout the specification and drawings with the same reference numerals, respectively.

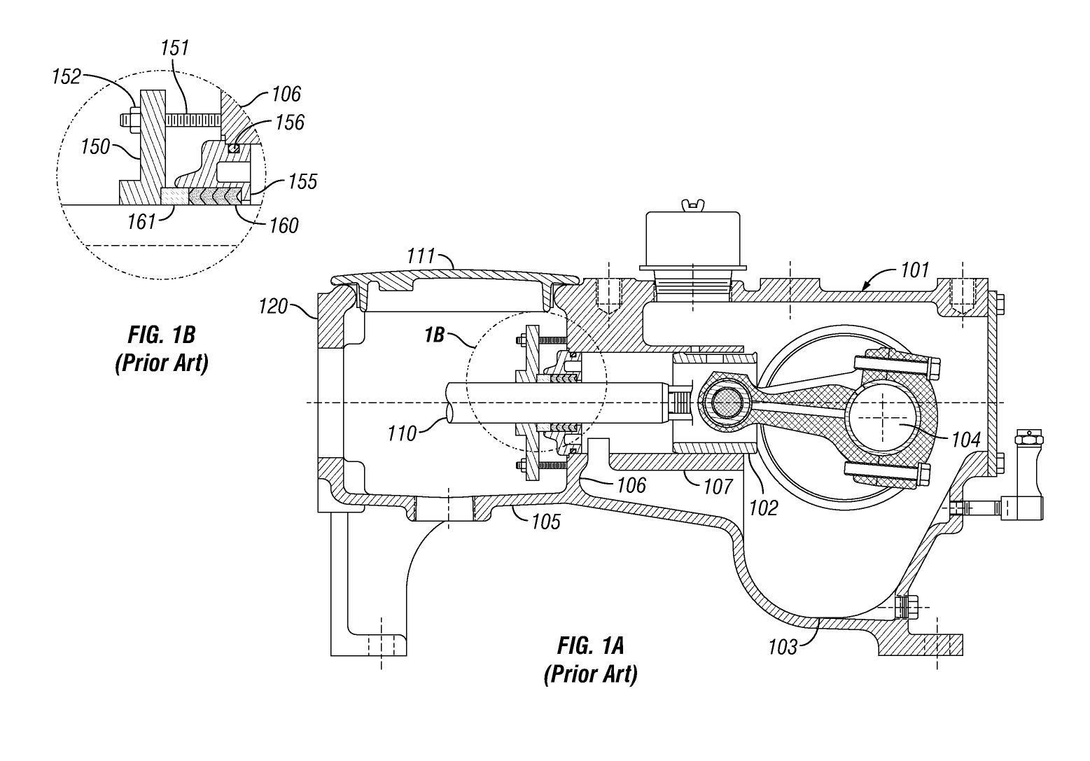

With reference against to FIG. 1A, one contributing factor to the leaking of fluid past the seal assembly 1B is the irregular motion of the pony rod 110. The crosshead 102 oscillates up and down within cylinder 107 due to the rotating shaft 104. The result is that the connected pony rod 110 moves up and down in a sinusoidal manner as it reciprocates back and forth through seal assembly 1B. To accommodate the sinusoidal movement, the lips of the chevron seals 160 flex with the pony rod 110, but the flexing is asymmetric and at the limit for providing a complete seal around the pony rod 110. The sinusoidal movement also can act like a pump to force fluid past the series of seals 160.

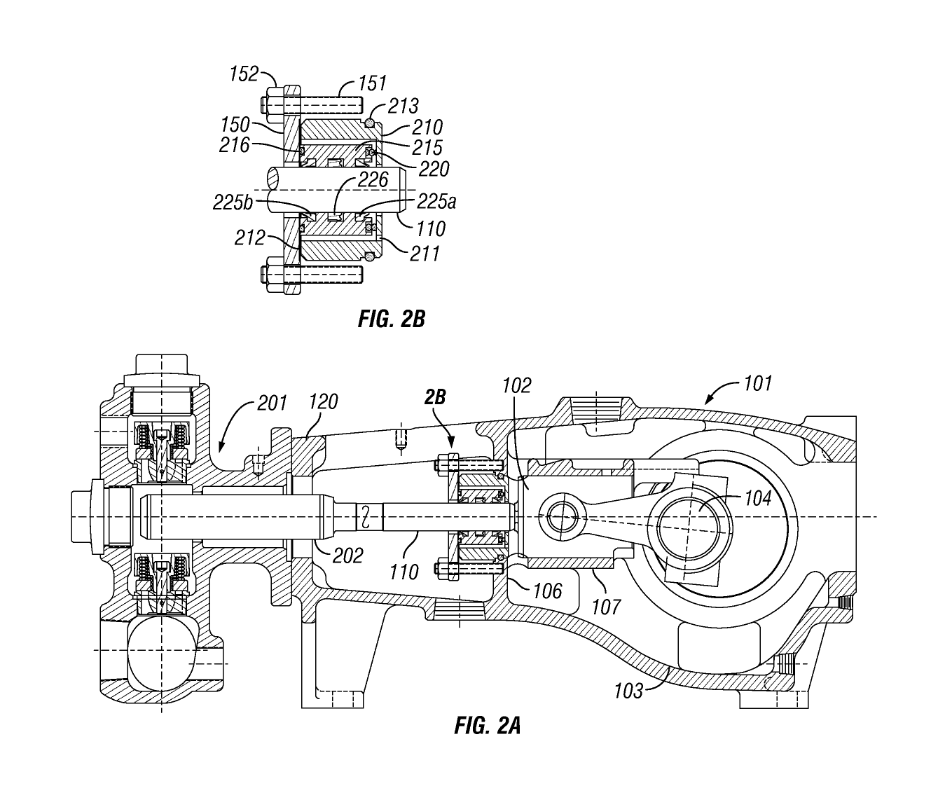

In FIG. 2A, a partial cross-section of a reciprocating pump in accordance with one embodiment is shown. FIG. 2A shows a portion of the fluid end 201, which is fastened to plate 120 on the power end 101. Pony rod 110 is connected to piston 202, which extends into the fluid end 201 to provide the pumping action for the reciprocating pump. Seal assembly 2B seals between the pony rod 110 and the opening in partition 106. Fluid leaks due to oscillation of the pony rod 110 are reduced or eliminated by allowing portions of the seal assembly to float in the radial direction with the pony rod 110 as it reciprocates.

FIG. 2B shows seal assembly 2B in greater detail. Seal assembly 2B includes a seal cartridge 215 contained within a seal housing 210. The seal housing 210 includes a seal 213 on its outer diameter to seal with the inside of the opening in partition 106. The seal cartridge 215 contains sealing elements on its inner diameter to seal around the pony rod 110. In this embodiment, the sealing elements are wiper seals 225a and 225b on opposite sides of a rod seal 226. The wiper seals 225a and 225b clean the outer diameter of the pony rod 110 to provide a cleaner surface for the rod seal 226 to seal around. Each of the sealing elements is disposed in a respective groove in the inner diameter of the seal cartridge 215. Those having ordinary skill in the art will appreciate that many combinations of rod seals, with or without wiper seals, may be used to provide the seal around the pony rod 110 without departing from the scope of the disclosure.

Seal assembly 2B is held in place by gland 150, which is secured to partition 106 by threaded fasteners 151 and 152. In other embodiments, the gland 150 may be threaded and secured directly to the partition 106 without separate threaded fasteners. By using a common method of securing seal assemblies to partition 106, seal assembly 2B may be designed to be retrofit with reciprocating pumps already in service. Those having ordinary skill in the art will appreciate that other mechanisms for securing the seal assembly 2B may be employed without departing from the scope of the disclosure. The seal housing 210 has an open end to receive the seal cartridge 215 and allow the fastening of gland 150 to provide compression of the seal cartridge 215 and its internal sealing elements, described further below. A gasket or O-ring 212 may be provided between the end of the seal housing 210 and gland 150 to provide a seal.

Continuing with FIG. 2B, the seal cartridge 215 is axially restrained between gland 150 and the inside surface of the seal housing 210. The seal cartridge 215 includes a seal 216 between its end and the gland 150. On the opposite end, the seal cartridge 215 includes a biasing element 220 between the seal cartridge 215 and the inside surface of the seal housing 210. The biasing element 220 provides a force between the opposite end of the seal cartridge 215 and the gland 150 to aid the effectiveness of seal 216. Suitable biasing elements include various springs, such as spring washers, helical springs, and wave springs. In another embodiment, the biasing element 220 may be an elastomeric element, such as but not limited to an elastomeric O-ring. In yet another embodiment, the biasing element 220 may be the same as seal 216 in order to avoid improper assembly of seal assembly 2B.

During operation of the reciprocating pump, seal cartridge 215 is able to move radially within the seal housing 210. As a result, the wiper seals 225a and 225b and rod seal 226 are able to be substantially centered about the pony rod 110 as it oscillates up and down with the crosshead 102. Biasing element 220 keeps the seal 216 between the seal cartridge 215 and the gland 150 to block that potential leak path as the seal cartridge 215 floats radially. Gasket 212 between the seal housing 210 and the gland 150 blocks that potential leak path. Any fluid that leaks behind the seal cartridge 215 may be drained back into the power end 101 through one or more drain holes 211 formed in the seal housing 210.

Embodiments of the disclosure may provide one or more of the following advantages. By allowing the seal cartridge 215 to float radially with the pony rod 110, the sealing elements within the seal cartridge 215 are substantially centered about the pony rod 110. Preventing misalignment of the sealing elements relative to the pony rod 110 reduces or eliminates fluid leakage that could otherwise occur with the up and down oscillation of the pony rod 110. With alignment maintained, the seal cartridge 215 and the sealing elements may also be selected to have closer tolerances around the pony rod 110 without concern for interference that could occur with prior art seal assemblies. The closer tolerances further reduce potential fluid leakage around the pony rod 110.

The modular design of the embodiments disclosed herein may also be easier to assemble in the field than conventional seal assemblies. Most of the components may be assembled together before placing them around the pony rod 110 inside the reciprocating pump. For example, seal 213 can be placed in the outside groove on the seal housing 210. Biasing element 220, seal 216, wiper seals 225a and 225b, and rod seal 226 can each be placed in their respective grooves in and on the seal cartridge 215. The seal cartridge 215 can then be placed into the seal housing 210. The only steps to be carried out inside the reciprocating pump would be to insert the pony rod 110 through opening in the seal housing 210 and place the seal housing 210 inside the opening in partition 106. The seal assembly 2B is then completed by securing the gland 150 to partition 106.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A seal assembly for providing a seal around a non-stationary rod, the seal assembly comprising:
a seal housing comprising a hollow body with first and second ends, wherein the first end comprises a first opening to allow the non-stationary rod to pass therethrough and the second end comprises a second opening to allow the non-stationary rod to pass therethrough;
a seal cartridge disposed within the seal housing and radially moveable within the seal housing; and
a rod seal disposed in an internal diameter of the seal cartridge.

2. The seal assembly of claim 1, further comprising:
a gland covering a portion of the first opening in the seal housing and axially retaining the seal cartridge within the seal housing, wherein the first opening receives the seal cartridge into the seal housing.

3. The seal assembly of claim 2, further comprising:
a seal disposed between the gland and the seal cartridge.

4. The seal assembly of claim 3, further comprising:
a biasing element disposed between the seal cartridge and the second end of the seal housing.

5. The seal assembly of claim 4, wherein opposing ends of the seal cartridge are symmetric and the biasing element is a seal.

6. The seal assembly of claim 2, wherein the seal assembly further comprises a gasket between the first end of the seal housing and the gland.

7. The seal assembly of claim 1, wherein the seal housing comprises a drain hole.

8. The seal assembly of claim 1, further comprising two rod wipers on opposing sides of the rod seal in the internal diameter of the seal cartridge.

9. The seal assembly of claim 8, wherein the rod seal and the two rod wipers are disposed in separate grooves formed in the internal diameter of the seal cartridge.

10. A reciprocating pump, comprising:
a power end comprising a reciprocating crosshead converting rotational motion from a rotating shaft to a reciprocal motion;
a fluid end comprising a fluid inlet, a fluid outlet, and a piston;
a pony rod extending from the reciprocating crosshead to the piston;
a partition between the reciprocating crosshead and the fluid end, wherein the partition comprises an opening through which the pony rod extends; and
a seal assembly disposed at the opening in the partition and providing a seal between the pony rod and the opening in the partition through which the pony rod extends, wherein the seal assembly comprises,
a seal housing comprising a hollow body with first and second ends, wherein the first end comprises a first opening to allow the reciprocating rod to pass therethrough and the second end comprises a second opening to allow the reciprocating rod to pass therethrough;
a seal cartridge disposed within the seal housing and radially moveable within the seal housing; and
a rod seal disposed in an internal diameter of the seal cartridge.

11. The reciprocating pump of claim 10, wherein the seal assembly further comprises a gland covering a portion of the first opening in the seal housing and axially retaining the seal cartridge within the seal housing, and wherein the first opening receives the seal cartridge into the seal housing.

12. The reciprocating pump of claim 11, wherein the seal assembly further comprises a seal disposed between the gland and the seal cartridge.

13. The reciprocating pump of claim 12, wherein the seal assembly further comprises a biasing element disposed between the seal cartridge and the second end of the seal housing.

14. The reciprocating pump of claim 13, wherein opposing ends of the seal cartridge are symmetric and the biasing element is a seal.

15. The reciprocating pump of claim 11, wherein the seal assembly further comprises a gasket between the first end of the seal housing and the gland.

16. The reciprocating pump of claim 11, wherein the gland is removably secured to the partition by a threaded fastener.

17. The reciprocating pump of claim 10, wherein the seal housing comprises a drain hole to allow fluid accumulated in the seal housing to flow back to a collection location in the power end.

18. The reciprocating pump of claim 10, wherein the seal assembly further comprises two rod wipers on opposing sides of the rod seal in the internal diameter of the seal cartridge.

19. The reciprocating pump of claim 18, wherein the rod seal and the two rod wipers are disposed in separate grooves formed in the internal diameter of the seal cartridge.
